(19) United States
(12) Patent Application Publication
(10) Pub. No.: US 2015/0067790 A1
(43) Pub. Date: Mar. 5, 2015

(54) Methods, Circuits, Devices, Systems and Associated Computer Executable Code for Discovering and Providing Digital Content

(71) Applicant: woorlds LTD, Tel Aviv (IL)

(72) Inventors: ZEEV OLSEKA, Rishpon (IL); Amos Talmor, Rannana (IL); Tamir Scherzer, Hertzelia (IL)

(73) Assignee: WOORLDS LTD, Tel Aviv (IL)

(21) Appl. No.: 14/470,232

(22) Filed: Aug. 27, 2014

Related U.S. Application Data
(60) Provisional application No. 61/870,912, filed on Aug. 28, 2013.

(51) Int. Cl. H04L 29/06; H04W 12/08

(52) U.S. Cl. CPC H04L 63/10; H04W 12/08; H04L 2463/101
USPC 726/4

(57) ABSTRACT

Disclosed are methods, circuits, devices, systems and computer executable code for discovering and providing digital content. Identifier of a wireless communication signal source may be associated with a specific store or collection of digital content.

### FIELD

The present invention generally relates to the fields of digital content management. More specifically, the present invention relates to methods, circuits, devices, systems and associated computer executable code for discovering and providing digital content.

### BACKGROUND

Content management, or CM, is the set of processes and technologies that support the collection, managing, and publishing of information in any form or medium. When stored and accessed via computers, this information has come to be referred to, simply, as content or, to be precise, digital content. Digital content may take the form of text (such as electronic documents), multimedia files (such as audio or video files), or any other file type that follows a content life cycle requiring management. Content management practices and goals vary by mission and by organizational governance structure. News organizations, e-commerce websites, and educational institutions all use content management, but in different ways.

Still, there remains a need, in the field of content management, for methods, circuits, devices, systems and associated computer executable code for discovering and providing digital content.

### SUMMARY

Disclosed, are methods, circuits, device s, systems and computer executable code for discovering and providing digital content; wherein identifier of a wireless communication signal source may be associated with a specific store or collection of digital content.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. Such apparatus may be specially constructed for the desired purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

The present invention relates to methods, circuits, devices, systems and computer executable code for discovering and providing digital content. According to some embodiments, an identifier of a wireless (i.e. radio frequency) communication signal source, such as a Wi-Fi Access Point beacon signal (SSID, BSSID, channel, encryption, technology, or any additional custom flags) or a cellular base station ID, may be associated with a specific store or collection of digital content (“content collection”). A party in control of, or otherwise associated with, an Access Point may register the given Access Point's identifier in an online directory, and a registration record in the directory for a given identifier may receive and/or otherwise include a network address, pointer, identifier and/or other information facilitating access to a networked data storage area associated with the given Access Point and to store a content collection associated with the given Access Point (content collection key), and manage access to this content according to user relation, permissions, physical presence, or connectivity state. Computer executable code running on a wireless computing and/or communication device (e.g. a cell phone, smart phone, tablet, etc.) may use a detected identifier to retrieve from the directory the content collection key associated with that Access Point and to access a content collection associated with the identifier, according to the permissions managed by the controlling party.

U.S. Provisional Patent Application No. 61/870,912, filed Aug. 28, 2013, is herein incorporated by reference in its entirety.

The subject matter described above is provided by way of illustration only and should not be constructed as limiting. While certain features of the invention have been illustrated and described herein, many modifications, substitutions, changes, and equivalents will now occur to those skilled in the art. It is, therefore, to be understood that the appended claims are intended to cover all such modifications and changes as falling within the true spirit of the invention.

What is claimed is:

1. A methods for discovering and providing digital content, the method comprising:
associating an identifier of a wireless communication signal source with a specific store or collection of digital content;
registering the identifier in an online directory; and
managing access to the digital content according to user relation, permissions, physical presence, or connectivity state.

2. A server for discovering and providing digital content, the server comprising:
an access mechanism operative to communicate with an online directory; and
storage containing instructions that, when executed, cause the server to register in the online directory an identifier of a wireless communication signal source with a specific store or collection of digital content;
wherein access to the digital content is managed according to user relation, permissions, physical presence, or connectivity state.
